(19) United States
(12) Patent Application Publication
(10) Pub. No.: US 2012/0255467 A1
(43) Pub. Date: Oct. 11, 2012

(54) DEVICE FOR MANAGING VALUABLES INCLUDING MONEY

(75) Inventors: Sven Kamrath, Linden (DE); Marc Rinderspacher, Hamburg (DE); Marco Zander, Kiel (DE); Tom Brey, Utersen (DE)

(73) Assignee: NOVOMATIC AG, Gumpoldskirchen (AT)

(21) Appl. No.: 13/382,961

(22) PCT Filed: Jul. 12, 2010
(86) PCT No.: PCT/EP2010/004229

§ 371 Date: Jun. 21, 2012

(30) Foreign Application Priority Data
Jul. 10, 2009 (DE) 20 2009 009 549.5

(51) Int. Cl. E05G 1/08

(52) U.S. Cl. 109/23; 109/53

(57) ABSTRACT

The invention refers to a device for management, collection, and/or dispensing of valuables, in particular money, with a locked vault area and an operator and service area, wherein all of the valuables as well as the vault area's controlling units are essentially arranged completely within the vault area, preferably in a certified vault, and essentially all control electronics is arranged in the operator and service area, whereby the vault area and the operator and service area exhibit separate locking systems. According the invention, a second vault area is provided in which the control electronics for controlling the controlling units in the first vault area is arranged wherein said second vault area is separated both from the first vault area for collecting the valuables and from the remaining operator and service area, and exhibits a locking system separate from that of the first vault area and of the operator and service area.

The invention refers to a device for management, collection, and/or dispensing of valuables, in particular money, with a locked vault and an operator and service area, wherein all of the valuables as well as the vault area's controlling units are essentially arranged completely within the vault area, preferably in a certified vault, and essentially all control electronics is arranged in the operator and service area, whereby the vault area and the operator and service area exhibit separate locking systems.

Cash machines, money exchange machines, ticket machines, and vending machines have been known for a long time from the state of the art.

A cash machine is a technical device for managing cash. The division is made into automated teller machines (ATMs), money deposit machines, and cash recycling machines. Cash machines are also called bank machines.

Cash machines enable the customer to withdraw cash from or deposit it to his checking or credit card account through self-service. Some machines also dispense foreign currencies or inform the customer about the account balance and past transactions. Financial institutions often operate such devices.

To withdraw money, the customer inserts a debit or credit card into the machine and enters a personal identification number (PIN). A central authorization office checks online to determine whether or not the personal identification number is correct and decides whether the payout can be made.

Newer-generation cash machines also enable cash deposit. The procedure resembles that for dispensing: The customer inserts the customer card into the machine. A cash-insertion slot then opens. The money is immediately checked for authenticity and booked to the customer's account. This way, the bank can also provide the money depositing service to its customers outside the office hours and the bank saves itself the enormous personnel expenses of operating a night depository. If the cash machine can recycle, verified money deposited by the customer can be paid out to subsequent customers whereby the bank decreases the labour of filling the machine.

Such money-management devices usually feature a certified vault area, such as CEN3, in which part of the money is housed, as well as another area in which the device's other components are housed. This latter is called the operator and service area below.

These machines are often equipped with a receipt printer for receipts or also a bank-statement printer. Here a printer that creates the receipt or the statement then outputs it to the customer is installed in the cash machine, cash exchange machine, pay machine, or even vending machine.

Furthermore, a computer or PC is usually also provided in the device to operate the device.

Servicing is required during the product cycle for a cash machine's various elements, such as the printer or the computer. For example, this can be the refilling of printer paper, software updates, or replacement of the element as a whole.

With the devices mentioned, the servicing procedure for the printer is usually arranged so that servicing requires opening the device. But by opening the device, it is possible that the servicing staff may have unauthorized access to money supplies or other machine internals or is able to reconnoitre them. It was therefore already suggested that all of the valuables as well as the vault area's controlling units such as the hopper or bank-note collection and/or dispensing mechanism and their electrical leads essentially be arranged completely in the vault area, preferably in a certified vault, while essentially all control electronics such as the PC, printer, and voltage supply is arranged in the operator and service area. Advantageously, the vault area and the operator and service area feature separate locking systems.

Accordingly, the certified vault housing must still be opened, if the money- or value-containing or guiding parts arranged in this area need to be serviced. Various service personnel can then provide this. Ordinary service personnel can be employed for the more common and less security-related maintenance and service work in the operator and service area, while for the less commonly arising maintenance and service work in the certified vault area, other, possibly specially trained and trusted personnel, can be employed.

For instance, the documents US 2002/0020736, A1, U.S. Pat. No. 4,615,280 and U.S. Pat. No. 4,884,514 show such for managing, collecting, and/or dispensing valuables.

The said operator and service area will be opened especially often in this connection to service the account-statement and/or the receipt printer. Often, the relevant paper supplies, for instance bank statement forms or receipt paper rolls, will be replaced or supplemented. Likewise, ink or toner cartridges on the printers are regularly replaced. Due to the frequency of access caused by this, unmonitored personnel often obtain entry, or proper maintenance work is really no longer carefully monitored.

In this connection it has been shown that the controller arranged in the operator and service area is vulnerable to manipulation. On the one hand there is the risk that the vault area's controlling units will be manipulated during service work through access to the control electronics in the control and service area. More dangerous, because scarcely subject to service-work monitoring, is, however, manipulation of the control electronics so that, for instance, by installing software, the card readers can be manipulated in a way that unauthorized debit or credit cards are accepted with likewise unverified PIN numbers, so that at a certain time after the actual service work, withdrawals can be made by simply inserting the unauthorized debit or credit card.

The invention addresses the task of creating a device for managing, collecting, and/or dispensing valuables of the type mentioned at the start, avoids disadvantages of the prior art, and builds upon the latter in an advantageous way. In particular, service access to the service and operator controls should be guaranteed without enabling access to the money supplies.

This objective is achieved through the combination of features given in claim 1. Preferred designs for the invention are the object of the dependent claims.

It is therefore proposed to withdraw access to the control electronics as well as to their interconnections, through which the vault area's controlling units can be actuated, from service personnel working in the operator and service area and to house it in a separate, secure location. According to the invention, a second vault area is provided in which the control electronics for controlling the controlling units in the first vault area is arranged wherein said second vault area is separated both from the first vault area for collecting the valuables and from the remaining operator and service area, and exhibits a locking system separate from that of the first vault area and of the operator and service area. By locking away the control electronics for the value-processing control elements in a separate, second safe area that is separately lockable, control-electronics manipulation can no longer occur during daily maintenance in the remaining operator and service area. In particular, at least one printer, and paper supplies for printing bank statements and/or receipts, is arranged in the said remaining operator and service area so that when replacing the cartridges and filling up the paper supplies, access to the control electronics is no longer possible. Access to the control electronics is possible only selectively, and if necessary under proper supervision, by opening the second safe area. At the same time, it is ensured here that the first safe area containing the valuables will remain inaccessible, while, conversely, during access to the first safe area, for example to replenish the money supply in it, no access to the control electronics is possible. Separate arrangement of the control electronics in a second vault area can further improve the security situation.

In further elaboration of the invention, the second vault area can be integrated into the operator and service area or can form a part of it; however strictly separated from the remaining part of said operator and service area and secured by a separate locking system. The second vault area can form an area within the operator and service area. For instance, the entire operator and service area can be locked by a service door behind which a part of the operator and service area, and the second vault area's door, are arranged so that the second vault area's door can only be opened after the operator and service area's door has been opened. Alternatively, or additionally, however, the second vault area can also exhibit a separately accessible vault door, i.e. a vault door independent of the operator and service area's locking system and/or independent of whether or not the operator and service area's door is open. According to one elaboration of the invention, the second vault area can exhibit a vault door that is to be opened from another side of the device than the operator and service area's door. In particular, the second vault area's and the operator and service area's doors can be opened from opposite sides. The said second vault area's vault door can, for instance, be designed in the form of a hatch that renders the second vault area accessible from a front side of the device.

To prevent “tapping into” the controller via the connection cable or direct manipulation of the first vault area's controlling units, advantageously no freely-accessible connection cables between the control electronics in the second vault area and the first vault area's controlling units from the operator and service area are provided to the operator and service area in a further elaboration of the invention. In accordance with an advantageous embodiment of the invention, wireless communication between the control electronics in the second vault and the controlling units in the first vault area may be provided for this, where advantageously the control electronics in the second vault area and the controlling units in the first vault area can each exhibit a wireless transmitting and/or receiving device.

However, in an advantageous embodiment of the invention, interconnection lines preferably in the form of a wire harness are provided between the control electronics in the second vault area and the controlling units in the first vault area, wherein one or more connecting lines are advantageously completely accommodated in the first and second vault areas. Advantageously, the first and second vault areas are arranged adjacent to and/or bordering each other for this and are only divided from each other by the vault-area wall so that the connecting line is guided through a passage opening in the vault-area walls or through a vault-area wall common to the two vault areas. Alternatively, or additionally, the connection lines between the two vault areas can also be separated from the rest of the operator and service area by a secure line casing made of a high-strength, tamper-proof material, for instance guided through a cable conduit made of high-strength, manipulation-proof material that connects the first and second vault areas to one another.

In a further elaboration of the invention, the connecting line or lines between the control electronics in the second vault area and the controlling units of the first vault area are here provided with a detachable connection interface, for example in the form of a contact plug, which is preferably arranged in the area between the first vault area and the second vault area. Appropriate maintenance or repair work can be conducted on the connecting lines via such a detachable interface without requiring simultaneous access to both of the vault areas. For instance, if a damaged cable in the second vault area needs to be replaced, this can be done by detaching the interface and reattaching it after the cable replacement without having to open the first vault area to do it.

The control electronics' PC is advantageously housed in the said second vault area, which on the one hand actuates the vault area's controlling units such as the hopper and/or the bank note collection/dispensing mechanism, and on the other controls additional electronic device components like the printer, screen, card-reader device, PIN-query units, and the like arranged in the service area.

It has proven especially advantageous in devices of the said type when all of the elements in the operator and service area not housed in the first and/or second vault areas are arranged as closely to one another as possible. Such a design leads to the least possible space requirement.

Furthermore, it has also proven advantageous when the operator and service area and/or the second vault area are separable from the first vault area.

In such an embodiment, it is then possible for the operator and service area to be fully interchangeable, if necessary, or for more complex maintenance tasks to be conducted in a different place while the significantly larger and heavier vault area can remain on site. The first vault area can also be advantageously separated from the second vault area to enable only the second vault area having to be removed during complicated maintenance work on the control electronics. The previously mentioned connection line's detachable interface is advantageous for this. Alternatively, or additionally, it can also be provided that the control electronics is detachably accommodated in the second vault area.

According to a further preferred embodiment of the present invention, essentially all of the control electronics such as the PC and the voltage supply is arranged in the second vault area, with the exception of the printer. The said printer and its paper supply are arranged in the operator and service area separate from the second vault area.

It is particularly advantageous when components with a higher maintenance frequency are arranged to be more easily accessible than components with lower maintenance frequency. So, for example, the relatively service-intensive printer can be arranged for easy accessibility, while components which normally rarely need maintenance or service, such as the power supply, can be arranged a little less accessibly. When, for instance, access to the operator and service area occurs from behind, then the printer could be arranged there right in front while the less often required components can be arranged farther toward the front of the device.

According to a further preferred embodiment of the present invention, the first and second vault areas, and the operator and service area form a unit in the device's service-ready state.

The described device can, for instance, be designed as a cash machine, pay machine, and/or vending machine.

The drawings below illustrate the design examples of the invention in more detail. Shown in this connection are:

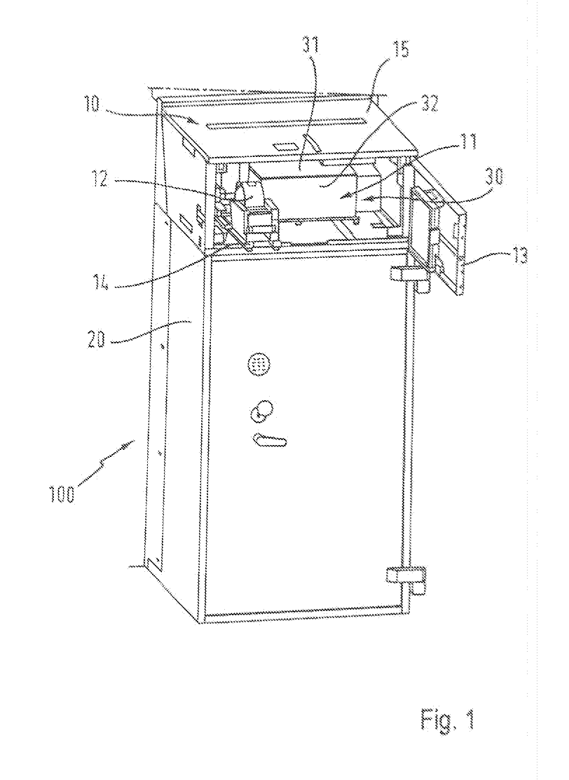

FIG. 1: A device according to a preferred embodiment of the invention, wherein the first vault area, arranged below, is represented closed and the service and operator area, arranged above it, open. The second vault area arranged in turn within the latter is represented as closed.

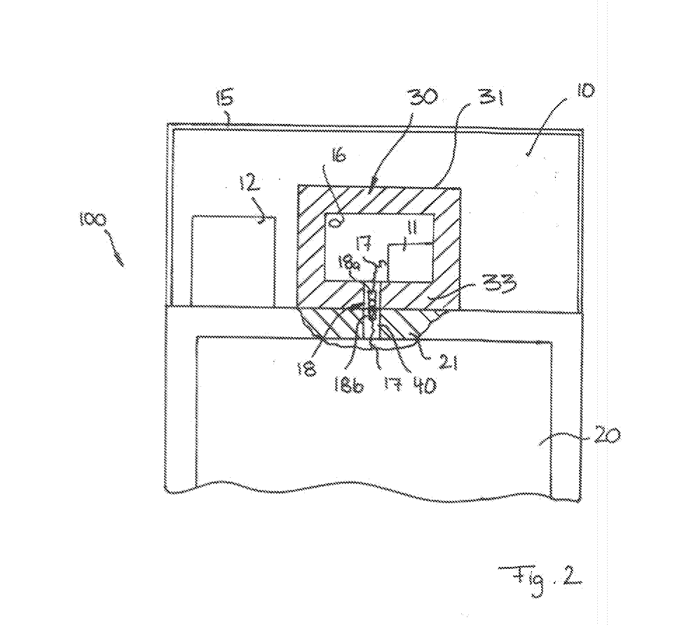

FIG. 2: A cutout, enlarged schematic representation of the second vault area arranged in the operator and service area and the connection of the control module in first vault area arranged within it.

In FIG. 1, a rear view of a device, 100, for managing, collecting, and/or dispensing valuables, particularly money, is represented according to an advantageous embodiment of the invention, wherein the service and operator area, 10, encompasses a housing, 15, which is constructed as a non-certified vault according to the preferred embodiment shown. It is shown in the open state in FIG. 1.

The first vault area, 20, is arranged beneath the service and operator area, 10, in the form of a certified vault.

In the embodiment shown, all money and valuables are contained in the certified first vault area, 20. Furthermore, the controlling units such as a hopper and/or a bank-note magazine device and/or a bank-note collection and/or dispensing unit are also protectively arranged in the certified vault area, 20. The electrical leads to the said first vault area's, 20's, controlling units are themselves advantageously arranged therein.

Those components not containing any money or other valuables, such as the computer, 11, the printer, 12, or the voltage supply, 16, are arranged in the operator and service area.

According to the preferred embodiment of the invention shown, the service and operator area, 10, can be opened for maintenance and service work via a door, 13.

In particular, the printer, 12, is arranged on rails, 14, up to the door, 13, of the service and operator area, 10, and can therefore be easily pulled out of the device, 100, from behind. Components arranged in the service and operator area, 10, that require maintenance less often, are arranged farther towards the front of the device, i.e. farther towards the back according to FIG. 1.

The control electronics, including the computer, 11, and possibly also its voltage supply, 16, are advantageously arranged inside of the said operator and service area, 10, in a second vault area, 30, which is arranged completely inside of the operator and service area, 10, in the design shown and is only accessible by opening the door, 13, of the operator and service area, 10.

The said second vault area, 30, can likewise be constructed as a certified vault. In any case, it possesses a high-strength vault housing, 31, the wall of which is constructed to be manipulation-proof and consists of high-strength material of sufficient wall thickness. The second vault area, 30, advantageously possesses considerably greater wall- and break-in-security than the housing, 15, of the operator and service area, 10.

The said second vault area, 30, possesses a separate locking system, which locks the second vault area, 30, independently of the first vault area, 20, and separately from the operator and service area, 10. In particular, the vault housing, 31, possesses a vault door, 32, which is accessible after opening the door, 13, of the operator and service area, 10, but is only to be opened separately or remains locked during access only to the printer, 12. Instead of the arrangement shown in FIG. 1, the said vault door, 32, can also be arranged on a side opposite the door, 13, of the operator and service area, 10, and opened from there, i.e. the vault door, 32, can in particular also be opened from a front side of the device. Accessibility from opposite sides enables maintenance on the control electronics from a separate room, i.e. the service technician need not enter the space in which the bank's employees conduct corresponding service work. In particular, the said vault door, 32, can also be arranged on a side opposite the door of the first vault area, 20. Arrangement of the doors on opposite sides is particularly advantageous when the device is integrated into a building wall or masonry wall so that the door arrangement on opposite sides enables accessibility from various building rooms.

The second vault area, 30, and the first vault area, 20, sit advantageously immediately on top of one another so that corresponding vault walls, 21 and 33, border one another; cf. FIG. 2.

The PC or computer, 11, arranged inside of the second vault area, 30, contains the control electronic, which actuates the money-guiding or processing units of the first vault area, 20. For this, the computer, 11, is connected by a connecting line, 17, to the controlling units of the first vault area, 20, wherein said connecting line, 17, is guided through a passage opening, 40, which passes through the walls of the two vault areas, 20 and 30, and connects these two vault areas, 20 and 30, with one another. The passage opening, 40, is naturally advantageously constructed to be as small as possible so that it offers no possibility of manipulating one of the vault areas from the other.

As FIG. 2 shows, the entire connecting line, 17, is advantageously provided with a detachable interface, 18, in the area of the said passage opening, 40, so that the connection line, 17, between the two vault areas, 20 and 30, can be separated. For example, a cable may thereby be replaced in the second vault area, 30, without having to open the first vault area, 20, to do it.

The said interface, 18, is advantageously constructed and/or arranged here in such a way that during work on the line interface in one of the vault areas, no access to the cable section in the other vault area is necessary and/or possible. In particular, the said interface, 18, can encompass two coupling parts, 18a and 18b, which are detachably connectable to one another. Each is arranged counter sunk in the passage opening, 40, and held in place with a mounting so that detaching or connecting one coupling part requires no manipulation or handling of the other coupling part. For instance, the coupling parts, 18a and 18b, can each be fastened countersunk in the passage opening, 40, by a snap connection so that, for instance, the part of the line in the upper vault area can be pulled out or inserted in from above without having to hold the lower part of the line in the lower vault area.

Said mounting for the coupling parts, 18, can be advantageously constructed here in such a way that detaching the respective coupling part, 18a or 18b, is only possible on the side from which line piece fastened to the respective coupling part, 18a or 18b exits. According to FIG. 2, that means the upper coupling part, 18a, can only be detached from above, while the lower coupling piece, 18b, can only be detached from below. For instance, this can be achieved by appropriately arranged snap tabs or the like, which are only accessible from one side.

According to the embodiment shown, all of the money or valuables are housed inside of the certified vault area, 20. The service and operator area, 10, the second vault area, 30, and the first vault area, 20, are in fact physically separated in a particularly secure manner, but are nevertheless housed in a device, 100.

Both vault areas, 20 and 30, can be separated and replaced singly or mutually, or together with the operator and service area, 10, by detaching connections. For instance, this can be made possible by a threaded and/or a screw connection, for example in the form of a screw bolt in vault area 20 and/or in vault area 30.

Moreover, both vault areas, 20 and 30, and the operator and service area, 10, also exhibit different locking systems.

The device, 100, shown in the figures can be constructed as a free-standing, column-like device. In elaboration of the invention, however, it can also be constructed as a built-in device that, for instance, can be built into a building wall so that essentially only the back side and the front side lying opposite shown in figure one are accessible from different sides of the wall.

1-12. (canceled)

13. A device for managing valuables comprising:
a housing having a service area including a printer;
a primary vault attached to the housing and having a primary vault locking system for storing valuables; and
a secondary vault mounted in the housing and having control electronics for operating the device, the secondary vault isolates the control electronics from the primary vault and from the service area.

14. A device according to claim 13, wherein the secondary vault is arranged inside of the service area.

15. A device as set forth in claim 14, wherein both the primary vault and secondary vault include control electronics, the control electronics of the secondary vault includes a connection line extending between the control electronics of the secondary vault and the control electronics of the primary vault.

16. A device as set forth in claim 15, wherein the connection line has a detachable interface.

17. A device as set forth in claim 16, wherein the detachable interface is countersunk in the secondary vault to inhibit tampering.

18. A device as set forth in claim 16, wherein the detachable interface is countersunk in the primary vault to inhibit tampering.

19. A device as set forth in claim 13, wherein the device has a service area door, a primary vault door and a secondary vault door, each of which, has a separate locking system.

20. A device as set forth in claim 19, wherein the secondary vault is enclosed by the service area so that access to the secondary vault is only achievable when the service area door is open.

21. A device as set forth in claim 16, wherein the housing includes sliding tracks, the printer mounts on the sliding tracks to enable service and maintenance of the printer.

22. A device for managing valuables comprising:
a housing having a service area including a printer;
a primary vault attached to the housing and having a primary vault locking system for storing valuables; and
a secondary vault mounted in the housing and having control electronics including a computer and a power supply for operating the device, the secondary vault isolates the control electronics from the primary vault and from the service area.

23. A device according to claim 22, wherein the secondary vault is arranged inside of the service area.

24. A device as set forth in claim 23, wherein the primary vault includes control electronics, the control electronics of the secondary vault includes a connection line extending between the control electronics of the secondary vault and the control electronics of the primary vault.

25. A device as set forth in claim 24, wherein the connection line has a detachable interface.

26. A device as set forth in claim 25, wherein the detachable interface is countersunk in the secondary vault to inhibit tampering.

27. A device as set forth in claim 25, wherein the detachable interface is countersunk in the primary vault to inhibit tampering.

28. A device as set forth in claim 22, wherein the device has a service area door, a primary vault door and a secondary vault door, each of which has a separate locking system.

29. A device as set forth in claim 28, wherein the secondary vault is enclosed by the service area so that access to the secondary vault is only achievable when the service area door is open.

30. A device as set forth in claim 29, wherein the housing includes sliding tracks, the printer mounts on the sliding tracks to enable service and maintenance of the printer.

31. A device capable of managing valuables comprising:
a housing having a service area including a printer;
a primary vault attached to the housing and having a primary vault locking system for storing valuables, the service area mounts on the primary vault; and
a secondary vault mounted in the service area and having control electronics;
the control electronics including a computer and a power supply for operating the device,
wherein the secondary vault isolates the control electronics from the primary vault and from the service area.

32. A device as set forth in claim 31, wherein the secondary vault includes a connection line extending from the secondary vault to the primary vault to enable electronic communication between the primary vault and the secondary vault.
